(19) United States
(12) Patent Application Publication
(10) Pub. No.: US 2025/0197671 A1
(43) Pub. Date: Jun. 19, 2025

(54) IRRADIATION-CROSSLINKABLE SILICONE COMPOSITION COMPRISING PT(OCTANE-2,4-DIONE)2 AS A CATALYST

(71) Applicants: ELKEM SILICONES FRANCE SAS, Lyon (FR); ACTIVATION, Chassieu (FR); UNIVERSITE CLAUDE BERNARD LYON 1, Villeurbanne (FR); CENTRE NATIONAL DE LA RECHERCHE SCIENTIFIQUE, Paris (FR); ECOLE SUPERIEURE DE CHIMIE, PHYSIQUE, ELECTRONIQUE DE LYON, Villeurbanne (FR)

(72) Inventors: Cédric YSACCO, Martigues (FR); Jean RAYNAUD, Villeurbanne (FR); Vincent MONTEIL, Lyon (FR); Cyril BOSSET, Lyon (FR); Vivien HENRYON, Serezin De La Tour (FR); Jérôme MONBRUN, Bénesse-Lès-Dax (FR); Perrine THEIL, Saint-Pierre De Chandieu (FR)

(73) Assignees: ELKEM SILICONES FRANCE SAS, Lyon (FR); ACTIVATION, Chassieu (FR); UNIVERSITE CLAUDE BERNARD LYON 1, Villeurbanne (FR); CENTRE NATIONAL DE LA RECHERCHE SCIENTIFIQUE, Paris (FR); ECOLE SUPERIEURE DE CHIMIE, PHYSIQUE, ELECTRONIQUE DE LYON, Villeurbanne (FR)

(21) Appl. No.: 18/859,727

(22) PCT Filed: Apr. 28, 2023
(86) PCT No.: PCT/EP2023/061214

§ 371 Date: Oct. 24, 2024

(30) Foreign Application Priority Data
Apr. 28, 2022 (FR) 2204023

(51) Int. Cl. C09D 183/04; C08G 77/08; C08G 77/12; C08G 77/20

(52) U.S. Cl. CPC C09D 183/04; C08G 77/08; C08G 77/12; C08G 77/20

(57) ABSTRACT

A silicone composition X that is cross-linkable by polyaddition reactions to form a silicone elastomer. In particular, a silicone composition X that is cross-linkable by photonic irradiation catalyzed by a hydrosilylation catalyst C, which is Pt(octane-2,4-dione)₂. Also, a method for preparing silicone elastomers using the silicone composition X and a method for hydrosilylation in which the catalyst is Pt(octane-2,4-dione)₂.

### FIELD OF THE INVENTION

The subject of the present invention is a silicone composition X cross-linkable by polyaddition reactions to form a silicone elastomer. In particular, the subject of the present invention is a silicone composition X cross-linkable by photonic irradiation catalyzed by a hydrosilylation catalyst C which is Pt(octane-2,4-dione)₂.

### STATE-OF-THE-ART

Silicone compositions cross-linkable by polyaddition reactions are generally thermally crosslinked in the presence of a platinum catalyst, in particular the Karstedt catalyst. However, several years ago, compositions cross-linkable by irradiation were developed. This type of composition cross-linkable by irradiation is in particular very useful for coating-type applications where a support is covered with a silicon coating. Further, this type of method has advantages because it consumes less energy than the thermal method, so savings can be achieved. It is particularly true when the irradiation is done by UV-LED systems.

The patent application WO9525734 describes photoactive organoplatinum complexes for crosslinking by hydrosilylation of SiH and SiVi organopolysiloxanes. These photoactive organoplatinum complexes are prepared by reacting a photosensitive ligand with the Karstedt complex. Just the same, the systems described in that application do not serve to get both a good reactivity under UV (rapid crosslinking under irradiation), and a good stability of the composition without irradiation (long gel time without irradiation). The organoplatinum complexes described may also have solubility problems in silicone compositions.

It is also known, for example from the European patent EP 0,398,701 to use Pt(acetylacetonate)₂ (or Pt(acac)₂) as a hydrosilylation catalyst for silicone compositions cross-linkable by irradiation. Nonetheless, Pt(acetylacetonate)₂ is suspected of damaging fertility or the unborn child (H361-CMR Reproductive Toxicity Category 2).

Further, it is not necessarily possible to use the systems described above when the irradiation is done by UV-LED systems. Indeed, the fact of working with a light source that is predominantly monochromatic like LEDs demands a more precise design of the photocatalytic system in order to maximize the effectiveness of the absorption of the photons, and therefore the reactivity of the system.

It is therefore necessary to develop photocatalytic systems which may deal with these disadvantages.

In this context, the present invention aims to satisfy at least one of the following objectives. One of the objectives of the invention is providing a composition cross-linkable by UV irradiation and in particular UV-LED.

Another objective of the invention is providing a composition cross-linkable by irradiation which is catalyzed by a composition with little or no toxicity.

Another objective of the invention is providing a composition cross-linkable by irradiation having a good reactivity.

Another objective of the invention is providing a composition cross-linkable by irradiation and having a good stability without irradiation.

Another objective of the invention is providing a photocatalytic system having a good solubility in silicone compositions.

### BRIEF SUMMARY OF THE INVENTION

These objectives, among others, are achieved by the present invention which relates in the first place to a silicone composition X cross-linkable by irradiation comprising:
a. at least one organopolysiloxane A having, per molecule, at least two alkenyl groups in C₂-C₁₂ bound to the silicon;
b. at least one organopolysiloxane B having, per molecule, at least two SiH units; and
c. a catalytically effective quantity of at least one hydrosilylation catalyst C, which is Pt(octane-2,4-dione)₂.

Surprisingly, the inventors showed that, contrary to Pt(acac)₂, Pt(octane-2,4-dione)₂ had the advantage of not being mutagenic. In fact, this compound was analyzed according to the Ames test: the Ames test is a widely used method which uses bacteria for verifying whether a given chemical product may cause DNA mutations in the tested organism. Unexpectedly, the Ames test was conclusive: Pt(octane-2,4-dione)₂ did not induce any mutagenic changes in the tested microorganisms.

Additionally, the fact of using a catalyst C which is Pt(octane-2,4-dione)₂ serves to increase the reactivity of the silicone composition X under irradiation, and in particular under UV-LED irradiation. The silicone composition X therefore crosslinks more rapidly than with Pt(acac)₂ or other Pt β-diketonate complexes. Finally, the silicone composition X is very stable when it is not irradiated. It is thus possible to store the non-crosslinked silicone composition X protected from light for several tens of days.

The catalyst C which is Pt(octane-2,4-dione)₂ also has a very good solubility in silicone compositions. This solubility is for example greater than for other Pt β-diacetonate complexes, which represents an advantage.

The composition X according to the invention thus has many advantages: it has a good stability and good reactivity, and the catalyst C, which is Pt(octane-2,4-dione)₂ has a good solubility in silicone compositions and is not a mutagenic compound according to the Ames test.

A subject of the present invention is also a method for preparation of a coating on a support, comprising the following steps:
application of a silicone composition X on a support, preferably a textile support, and
crosslinking of said composition by electronic or photonic irradiation, preferably by exposure to an electron beam, by exposure to gamma rays, or by exposure to radiation with a wavelength included between 100 nm at 450 nm, preferably to UV radiation.

Another subject of the present invention is a coated support obtainable according to said method.

Another subject of the present invention is the use of the silicone composition X for the preparation of silicone elastomers.

Another subject to the present invention is a pre-mixture for a silicone composition comprising:
at least one organopolysiloxane A having, per molecule, at least two alkenyl groups in C₂-C₁₂ bound to the silicon;
at least one hydrosilylation catalyst C, which is Pt(octane-2,4-dione)₂.

### Definitions

In the present application, “silicone composition cross-linkable by irradiation” is understood to mean a silicone composition comprising at least one organopolysiloxane which can be hardened by electronic or photonic irradiation. Exposure to an electron beam may be indicated among the electronic irradiations. Exposure to UV radiation or exposures to gamma rays may be indicated among the photonic irradiations. Preferably, the irradiation is done by exposure to a radiation with a wavelength included between 100 nm and 450 nm, or between 200 nm and 405 nm.

In the present text, “UV” means ultraviolet. Ultraviolet radiation is defined as electromagnetic radiation with a wavelength included between about 100 nm and about 405 nm, which is beyond the visible light spectrum.

Further, in the present text, “LED” is the abbreviation well known to the person skilled in the art for “light-emitting diode.”

Unless indicated otherwise, all the viscosities of the silicone oils in question in the present disclosure correspond to a dynamic viscosity magnitude at 25° C. called “Newtonian,” meaning the dynamic viscosity which is measured, in a well-known manner, with a Brookfield viscosity meter, has a sufficiently low shearing velocity gradient so that the measured viscosity is independent of the velocity gradient.

In the present description, “textile” is a generic term encompassing all textile structures. The textiles may be made up of yarns, fibers, filaments and/or other materials. They particularly comprise flexible fabrics, whether they are woven, bonded, knit, braided, felt, needled, sown, or made by another manufacturing mode. “Yarn” is understood to mean a continuous multifilament object, a continuous yarn resulting from assembly of several yarns or a thread of continuous fibers, resulting from a single type of fiber, or a mixture of fibers. “Fiber” is understood, for example, to mean a short or long fiber, a fiber intended to be worked in spinning or for manufacturing of nonwoven articles or tow intended to be cut for forming short fibers. The textile may particularly be made of yarn, fibers and/or filaments having undergone one or several processing steps before producing the textile surface, such as for example steps of texturing, drawing, drawing-texturing, oiling, relaxation, thermal setting, twisting, fixing, crapping, washing and/or dyeing.

In the present application, all the percentages and ppm are indicated by weight unless otherwise indicated.

### DETAILED DESCRIPTION OF THE INVENTION

### Crosslinkable Silicone Composition X

The subject to the present invention is a silicone composition X cross-linkable by irradiation comprising:
a. at least one organopolysiloxane A having, per molecule, at least two alkenyl groups in C₂-C₁₂ bound to the silicon;
b. at least one organopolysiloxane B having, per molecule, at least two SiH units; and
c. a catalytically effective quantity of at least one hydrosilylation catalyst C, which is Pt(octane-2,4-dione)₂.

According to an embodiment, the composition X is cross-linkable by exposure to radiation with a wavelength included between 100 nm and 450 nm, in particular UV radiation.

The organopolysiloxane A having, per molecule, at least two alkenyl groups in C₂-C₁₂ bound to the silicon may in particular be formed of:
at least two siloxyl functions with the following formula: Y^{a}R¹_{b}SiO_{(4-a-b)/2} where:
Y is a C₂-C₁₂ alkenyl, preferably vinyl;
R¹ is a monovalent hydrocarbon group having 1 to 12 carbon atoms, preferably selected from alkyl groups having 1 to 8 carbon atoms such as methyl, ethyl, and propyl groups, which could be substituted by at least one halogen atom such as chlorine or fluorine, cycloalkyl groups with 3 to 8 carbon atoms and aryl groups having 6 to 12 carbon atoms; and a=1 or 2, b=0, 1 or 2 and a+b=1, 2 or 3; and
possibly functions of the following form: R¹_{c}SiO_{(4-c)/2}
where R¹ has the same meaning as above and c=0, 1, 2 or 3.

It is understood in the above formulas that if several R¹ groups are present, they may be identical or different from each other.

These organopolysiloxanes A may have a linear structure, essentially made up of siloxy functions “D” selected from the group made up by the siloxy functions Y₂SiO_{2/2}, YR¹SiO_{2/2} and R¹₂SiO_{2/2}, and terminal siloxy functions “M” selected from the group made up of the siloxyl functions YR¹₂SiO_{1/2}, Y₂R¹SiO_{1/2} and R¹₃SiO_{1/2}. The symbols Y and R¹ are as described above.

The following groups may be listed as examples of terminal functions “M”: trimethylsiloxy, dimethylphenylsiloxy, dimethyl(vinyl)siloxy or dimethylhexenylsiloxy.

The following groups may be listed as examples of functions “D”: dimethylsiloxy, methylphenylsiloxy, diphenylsiloxy, methyl(vinyl)siloxy, methylbutenylsiloxy, methylhexenylsiloxy, methyldecenylsiloxy or methyldecadienylsiloxy.

The following are some examples of organopolysiloxanes which may be organopolysiloxanes A according to the invention:
a poly(dimethylsiloxane) with terminal dimethyl(vinyl)silyls;
a poly(dimethylsiloxane-co-methylphenylsiloxane) with terminal dimethyl(vinyl)silyls;
a poly(dimethylsiloxane-co-methylvinylsiloxane) with terminal dimethyl(vinyl)silyls;
a poly(dimethylsiloxane-co-methyl(vinyl)siloxane) with terminal trimethylsilyls; and
a cyclic poly(methyl(vinyl)siloxane).

In the most recommended form, the organopolysiloxane A contain terminal dimethyl(vinyl)silyl functions and even more preferably the organopolysiloxane A is a poly(dimethylsiloxane) with terminal dimethyl(vinyl)silyls.

A silicone oil generally has a viscosity included between 1 mPa·s and 2,000,000 mPa·s. Preferably, said organopolysiloxanes A are oils with dynamic viscosity included between 20 mPa·s and 300,000 mPa·s, preferably between 100 mPa·s and 200,000 mPa·s à 25° C., and more preferably between 600 mPa·s and 150,000 mPa·s.

Optionally, the organopolysiloxanes A may further contain siloxyl functions “T” (R¹SiO_{3/2}) and/or siloxyl functions “Q” (SiO_{4/2}). The R¹ are as described above. The organopolysiloxanes A then have a branched structure. The following are some examples of branched organopolysiloxanes which may be organopolysiloxanes A according to the invention:
a poly(dimethylsiloxane)(methylsiloxane) with terminal trimethylsilyls and dimethyl(vinyl)silyls, made up of “M” trimethylsiloxy, “M” dimethyl(vinyl)siloxy, “D” dimethylsiloxy and “T” methylsiloxy functions;
a resin made up of “M” trimethylsiloxy, “M” dimethyl(vinyl)siloxy and “Q” functions; and
a resin made up of “M” trimethylsiloxy, “D” methyl(vinyl)siloxy and “Q” functions.

However, according to an embodiment, the silicone composition X does not comprise branched organopolysiloxanes or resins comprising alkenyl functions with C₂-C₁₂.

Preferably, the organopolysiloxane compound A has an alkenyl function concentration by mass included between 0.001% and 30%, preferably between 0.01% and 10%, preferably between 0.02 and 5%.

The silicone composition X preferably comprises from 50% to 95% organopolysiloxane A, more preferably from 60% to 87% by weight of organopolysiloxane A and even more preferably from 70% to 85% by weight of organopolysiloxane A relative to the total weight of the silicone composition X.

The silicone composition X may comprise a single organopolysiloxane A or a mixture of several organopolysiloxanes A having for example different viscosities and/or different structures.

The organopolysiloxane B is an organohydrogenpolysiloxane comprising at least two, and preferably at least three, hydrogensilyl functions or Si—H functions per molecule.

The organohydrogenpolysiloxane B may advantageously be an organopolysiloxane comprising at least two, preferably at least three, siloxyl functions with the following formula:

H_{d}R²ₑSiO_{(4-d-e)/2}

where:
the radicals R², identical or different, represent a monovalent radical having 1 to 12 carbon atoms;
d=1 or 2, e=0, 1 or 2 and d+e=1, 2 or 3;
and possibly other functions with the following formula: R²_{f}SiO_{(4-f)/2}
where R² has the same meaning as above and f=0, 1, 2 or 3.

It is understood in the above formulas that if several R² groups are present, they may be identical or different from each other. Preferably R² may represent a monovalent radical selected from the group made up of alkyl groups having 1 to 8 carbon atoms, which could be substituted by at least one halogen atom such as chlorine or fluorine, cycloalkyl groups with 3 to 8 carbon atoms and aryl groups having 6 to 12 carbon atoms. R² may advantageously be selected from the group made up of methyl, ethyl, propyl, 3,3,3-trifluoropropyl, xylyl, tolyl and phenyl.

In the above formula, the symbol d is preferably equal to 1.

The organohydrogenpolysiloxanes B may have a linear, branched or cyclic structure. The degree of polymerization is preferably greater than or equal to 2. Generally, it is below 5000.

When it involves linear polymers, these are essentially made up of siloxyl functions selected from the functions with following formulas D: R²₂SiO_{2/2} or D′: R²HSiO_{2/2}, and terminal siloxyl functions selected from functions with the following formula M: R²³SiO_{1/2} or M′: R²₂HSiO_{1/2} where R² has the same meaning as above.

Some examples of organohydrogenpolysiloxanes which could be organopolysiloxanes B according to the invention comprising at least two hydrogen atoms bound to a silicon atom are:
a poly(dimethylsiloxane) with terminal hydrogenmethlysilyls;
a poly(dimethylsiloxane-co-methyl hydrogen siloxane) with terminal trimethylsilyls;
a poly(dimethylsiloxane-co-methyl hydrogen siloxane) with terminal hydrogendimethylsilyls;
a poly(methyl hydrogen siloxane) with terminal trimethylsilyls; and
a cyclic poly(methyl hydrogen siloxane).

When the organohydrogenpolysiloxane B has a branched structure, it is preferably selected from the group made up of silicone resins with the following formulas:
M′Q where the hydrogen atoms bound to the silicon atoms are born on the groups M;
MM′Q where the hydrogen atoms bound to the silicon atoms are born on a portion of the M functions;
MD′Q where the hydrogen atoms bound to the silicon atoms are born on the groups D;
MDD′Q where the hydrogen atoms bound to the silicon atoms are born on a portion of the groups D;
MM′TQ where the hydrogen atoms bound to the silicon atoms are born on a portion of the M functions;
MM′DD′Q where the hydrogen atoms bound to the silicon atoms are born by a portion of the M and D functions;
and mixtures thereof,
with M, M′, D and D′ such as previously defined; T: siloxyl function with formula R²₃SiO_{1/2}; and Q: siloxyl function with formula SiO_{4/2} where R² has the same meaning as above.

Preferably, the organohydrogenpolysiloxane compound B has a mass concentration of hydrogensilyl functions Si—H included between 0.2% to 91%, more preferably between 3% and 80%.

Now considering the entire silicone composition X, the molar ratio of the hydrogensilyl functions Si—H over the alkenyl functions may advantageously be included between 0.2 and 20, preferably between 0.5 and 15, more preferably between 0.5 and 10, and still more preferably between 0.5 and 5.

Preferably, the viscosity of the organohydrogenpolysiloxane B is included between 1 mPa·s and 5000 mPa·s, more preferably between 1 mPa·s and 2000 mPa·s, and even more preferably between 5 mPa·s and 1000 mPa·s.

The silicone composition X preferably comprises from 0.1% to 10% organohydrogenpolysiloxane B, and even more preferably from 0.5% to 5% by weight relative to the total weight of the silicone composition X.

The silicone composition X may comprise a single organohydrogenpolysiloxane B or a mixture of several organohydrogenpolysiloxane B having for example different viscosities and/or different structures.

According to an embodiment, the silicone composition X may comprise a mixture of:
at least one organohydrogenpolysiloxane B such as described above comprising two SiH functions per molecule; and
at least one organohydrogenpolysiloxanes B such as described above comprising at least three SiH functions per molecule.

In the context of the invention, the hydrosilylation catalyst C is Pt(octane-2,4-dione)₂. The quantity by weight of catalyst C, calculated by weight of metal platinum, is generally included between 1 and 400 ppm, preferably between 2 and 200 ppm, and more preferably between 5 and 100 ppm, based on the total weight of the silicone composition X.

Pt(octane-2,4-dione)₂ has two diastereomers, cis and trans

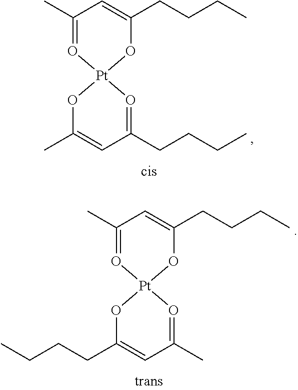

The cis:trans ratio in the hydrosilylation catalyst C is included between 0:100 and 100:0. It is thus possible to use as hydrosilylation catalyst C only the cis diastereomer, only the trans diastereomer, or a mixture of the two diastereomers.

According to an embodiment, Pt(octane-2,4-dione)₂ is a mixture of cis and trans diastereomers. The cis:trans ratio may be included between 90:10 and 10:90, or between 75:25 and 25:75. According to a specific embodiment, the mixture mostly comprises the cis diastereomer.

Pt(octane-2,4-dione)₂ may be synthesized by reacting the octane-2,4-dione ligand with a platinum precursor, like K₂PtCl₄, in the presence of a base, like NaOH.

The silicone composition X according to the invention may contain a crosslinking inhibitor D. Crosslinking inhibitors are intended to slow the crosslinking reaction and are also called retarders. Crosslinking inhibitors are well known from the prior art. The following may be listed as examples cyclic polymethylvinylsiloxanes and acetylenic alcohols described in patent U.S. Pat. No. 3,923,705, acetylenic alcohols described in patent U.S. Pat. No. 3,445,420, heterocyclic amines described in patent U.S. Pat. No. 3,188,299, diallylmaleate and other dialkylesters described in patent U.S. Pat. No. 4,256,870, olefinic siloxanes described in patent U.S. Pat. No. 3,989,667, and dialkylethynedicarboxylates described in patent U.S. Pat. No. 4,347,346. The following classes of inhibitors may also be listed: hydrazines, triazoles, phosphines, mercaptans, nitrogenous organic compounds, acetylenic alcohols, silyl acetylenic alcohols, maleates, fumarates, ethylenic or aromatic unsaturated amides, unsaturated ethylenic isocyanates, olefinic siloxanes, unsaturated hydrocarbon monoesters and diesters, conjugated ene-ynes, hydroperoxides, nitriles and diaziridines. The crosslinking inhibitor D is preferably selected from 1,3,5,7-tetramethyl-1,3,5,7-tetravinyl-cyclotetrasiloxane, 1-ethynyl-1-cyclohexanol (ECH), 3-methyl-1-butyn-3-ol, 2-methyl-3-butyn-2-ol, 3-butyn-1-ol, 3-butyn-2-ol, propargylic alcohol, 2-phenyl-2-propyn-1-ol, 3,5-dimethyl-1-hexyn-3-ol, 1-ethynylcyclopentanol, 1-phenyl-2-propynol, 3-methyl-1-penten-4-yn-3-ol, 3-methyl-1-dodecyne-3-ol, 3,7,11-trimethyl-1-dodecyne-3-ol, ordiphenyl-1,1-propyne-2-ol-1,3,6-diethyl-1-nonyne-3-ol, 3-methyl-1-pentadecyne-3-ol, and mixtures thereof. The acetylenic alcohols are strongly preferred crosslinking inhibitors D according to the invention, and more specifically 1-ethynyl-1-cyclohexanol (ECH). According to an embodiment, the silicone composition X comprises between 2 and 10,000 ppm of crosslinking inhibitor D, preferably between 5 and 1000 ppm, relative to the total weight of the silicone composition X.

The cross-linkable silicone composition X may comprise a filler E. According to an embodiment, the silicone composition X comprises between 5% and 40% by weight of a filler E relative to the total weight of the silicone composition X. Advantageously, the silicone composition X comprises between 8% and 20% by weight of filler E.

The filler E which could be provided is preferably mineral. The filler E may be a very finely divided product whose average specific diameter is less than 0.1 μm. The filler E may in particular be siliceous. As for the siliceous materials, they may play the role of reinforcing or semi-reinforcing filler. The reinforcing siliceous fillers are selected from colloidal silicas, silica combustion and precipitation powders, or mixtures thereof. These powders have an average particle size generally below 0.1 μm and a specific BET surface area over 30 m²/g, preferably included between 30 and 350 m²/g. Semi-reinforcing siliceous fillers such as diatomaceous earth and/or crushed quartz may also be used. These silicas may be incorporated as they are or after having been treated by organosiliceous compounds typically used for this purpose. Among these compounds are methylpolysiloxanes such as hexamethyldisiloxane, octamethylcyclotetrasiloxane, methylpolysilazanes such as hexamethyldisilazane, hexamethylcyclotrisilazane, tetramethyldivinyldisilazane, chlorosilanes such as dimethyldichlorosilane, trimethylchlorosilane, methylvinyldichlorosilane, dimethylvinylchlorosilane, alcoxysilanes such as dimethyldimethoxysilane, dimethylvinylethoxysilane, trimethylmethoxysilane, and mixtures thereof. Concerning the non-siliceous mineral materials, they may participate as semi-reinforcing mineral filler or packing. Examples of these non-siliceous fillers which can be used alone or in mixture are calcium carbonate, which could have a surface treatment by an organic acid or by an organic acid ester, fired clay, rutile type titanium oxide, oxides of iron, zinc, chrome, zirconium, and magnesium, the various forms of alumina (hydrated or not), boron nitride, lithopone, barium meta-borate, barium sulfate and glass microbeads. These fillers are coarser with generally an average particle diameter over 0.1 μm and a specific surface area generally under 30 m²/g. These fillers may have had a surface modification by treatment with various organosiliceous compounds typically used for this purpose.

Preferably, the filler E is silica, and even more preferably fumed silica. Advantageously, the silica has a BET specific surface area included between 75 and 410 m²/g.

The silicone composition X may also comprise other functional additives typical in silicone compositions. The following may be listed as families of functional additives: adhesion promoters, adhesion modulators, silicone resins, additives for increasing the consistency, additives for thermal resistance, oil resistance, fire resistance, for example metal oxides, virucides, bactericides, anti-abrasion additives, and pigments (organic or mineral).

According to a preferred embodiment, the silicone composition X according to the invention comprises, based on the total weight of the silicone composition X:
50% to 95%, preferably 60% to 87%, of an organopolysiloxane A having, per molecule, at least two alkenyl groups in C₂-C₁₂ bound to the silicon;
0.1% to 10%, preferably 0.5% to 5%, of an organopolysiloxane B having, per molecule, at least two SiH units; and
1 ppm to 400 ppm, preferably 2 ppm to 200 ppm, and more preferably from 5 to 100 ppm (calculated in parts per million of metal) of a hydrosilylation catalyst C which is Pt(octane-2,4-dione)₂; and
optionally, preferably between 5% and 40% of a filler E.

The silicone composition X may be prepared by mixing all the various components as described above.

According to an embodiment, the silicone composition X according to the invention may be prepared from a two-component system characterized in that it has two distinct parts intended to be mixed in order to form said silicone composition X, and in that one of the parts comprises the catalyst C and does not comprise the organopolysiloxane B, whereas the other part comprises the organopolysiloxane B and does not comprise the catalyst C.

Alternatively, the silicone composition X according to the invention may be a single-component system.

Another subject to the present invention is a pre-mixture for a silicone composition comprising:
at least one organopolysiloxane A having, per molecule, at least two alkenyl groups in C₂-C₁₂ bound to the silicon; and
at least one hydrosilylation catalyst C, which is Pt(octane-2,4-dione)₂.

In said premixture, the quantity by weight of hydrosilylation catalyst C, calculated by weight of metal platinum, is generally included between 0.1% and 10% based on the total weight of the pre-mixture.

The pre-mixture may optionally comprise a co-solvent, for example hexamethyldisiloxane or a short silicon oil, typically having a viscosity below 100 mPa·s.

### Method for Preparation of a Coating on a Support

The invention also concerns a method for preparation of a coating on a support, comprising the following steps:
application of a silicone composition X on a support, preferably a textile support, and
crosslinking of said composition by electronic or photonic irradiation, preferably by exposure to an electron beam, by exposure to gamma rays, or by exposure to radiation with a wavelength included between 100 nm at 450 nm, preferably a UV radiation.

The application of the silicone composition X may be done by continuously or discontinuously depositing said silicone composition X on at least one surface of said support.

Deposition may typically be done by transfer, by kiss roll or by spraying using a nozzle, a doctor blade, a rotating screen or a reverse roll. The thickness of the layer with the silicone composition X deposited on the support may be included between 0.1 mm and 0.8 mm, preferably between 0.3 mm and 0.6 mm and more preferably still between 0.4 mm and 0.5 mm.

According to an embodiment, the crosslinking step of the method according to the invention is done by UV radiation with a wavelength included between 100 nm and 405 nm.

According to a preferred embodiment of the invention, the radiation is ultraviolet light with a wavelength shorter than or equal to 405 nm. According to a preferred embodiment of the invention, the radiation is ultraviolet light with a wavelength longer than 100 nm.

The UV radiation may be emitted by doped or un-doped mercury vapor lamps whose emission spectrum extends from 100 nm to 405 nm. Light sources such as light emitting diodes, better known under the acronym “LED,” which deliver points of UV or visible light may also be used.

According to a preferred embodiment, the crosslinking of said silicone composition X is done by irradiation with UV radiation whose source is a UV-LED lamp. Said UV-LED lamp may emit radiation with a wavelength of 365 nm, 385 nm, 395 nm or 405 nm. Preferably, the UV-LED lamp is a lamp emitting at 395 nm.

The power of the UV-LED lamp is preferably included between 2 W/m² and 200,000 W/m².

According to a preferred embodiment, the irradiation of the silicone composition X is done continuously, by passage of the support under the UV-LED lamp. The speed of passage and the passage number may be defined such that the total irradiation of the silicone composition takes place over a time included between 1 s and 60 s, preferably between 2 s and 40 s, and even more preferably between 3 s and 15 s. In that way, the energy received by the silicone composition X by irradiation is preferably included between 1 J/m² and 1200 J/cm², preferably between 5 J/m² and 5 J/cm².

According to a preferred embodiment, the crosslinking step is implemented without inerting. Just the same, proceeding under inert atmosphere, for example under nitrogen, argon or oxygen depleted air, is not excluded.

The crosslinking step is implemented at a temperature included between 15° C. and 60° C., more preferably between 20° C. and 40° C., and still more preferably at ambient temperature, which is typically about 25° C.

According to the invention, any type of support may be used, in particular, textile supports. For information, the following may be listed under textile supports:
natural textiles, such as: textiles of vegetable origin, such as cotton, linen, hemp, jute, coconut, cellulose fibers from paper; textiles of animal origin, like wool, fur, leather and silks;
artificial textiles, such as: cellulose textiles, like cellulose or derivatives thereof; and protein textiles of animal or vegetable origin; and
synthetic textiles, such as polyester, polyamide, polymalic alcohols, polyvinyl chloride, polyacrylonitrile, polyolefins, acrylonitrile, (meth)acrylate-butadiene-styrene copolymers and polyurethane.

The synthetic textiles resulting from polymerization or polycondensation may in particular comprise different types of additives in their matrix, such as pigments, delustrants, mattifying agents, catalysts, thermal and/or light stabilizers, antistatic agents, flame retardants, antibacterial, antifungal and/or anti-mite agents.

The following may in particular be listed as types of textile surfaces: surfaces resulting from straight interlacing of yarns or fabrics, surfaces resulting from curved loop interlacing of yarns or knits, multiline or tulle surfaces, nonwoven surfaces, and composite surfaces.

The textile support used in the method from the present invention may be made up of one or several textiles, identical or different, assembled in various ways. The textile may be single or multi-layer. The textile support may for example be made up of a multilayer structure which may be made by various assembly means, such as mechanical means like sewing, welding, or spot or continuous adhesive.

The textile support may, beyond the coating method according to the present invention, undergo one or more other subsequent treatments, also called finishing or ennobling treatment. These other treatments may be done before, after or during said coating process from the invention. The following may be listed as other treatments: dying, printing, laminating, coating, assembly with other textile materials or surfaces, washing, degreasing, preforming or setting.

According to an embodiment, the support is an open-work and/or elastic textile support.

A textile is called “openwork” when it comprises free spaces not made up of textile. Said free spaces (which may be designated by pores, openings, cells, holes, interstices or gaps) may or may not be distributed uniformly over the textile. These free spaces may in particular be created during preparation of the textile. For the coating of the silicone composition from the invention to be effective, it is preferable that the smallest of the dimensions of these free spaces be less than 5 mm, in particular less than 1 mm.

Textile is called “elastic” when it has a rate of elasticity over 5%, preferably over 15%. The rate of elasticity of a textile may typically go up to 500%. The rate of elasticity represents the elongation percentage of the textile when it is stretched to the maximum. The elongation may be solely longitudinal, solely transverse, or longitudinal and transverse.

The textile support may be lace or an elastic band.

Another subject of the present invention is a coated support obtainable according to said method.

The resulting coated textile supports, as is or transformed into textile articles, may be used in many applications such as, for example, in the clothing field, in particular as lingerie like lace for tops, stockings or bras, and sports clothes, and hygiene articles such as elastic bandages or dressings.

### Other Applications

The subject of the present invention is also the use of Pt(octane-2,4-dione)₂ as hydrosilylation catalyst.

Another subject of the present invention is the use of the silicone composition X for the preparation of silicone elastomers.

The invention also relates to the use of the composition X according to the invention in the electronics field, for example for the preparation of conformal coatings for printed circuits, and for potting of microcircuits and electronic components such as IGBTs.

The invention also concerns the use of the composition X according to the invention for the preparation of articles of silicone elastomer by an additive manufacturing method.

The additive manufacturing methods are also known as 3D printing methods. This description generally comprises the ASTM F2792-12a designation, “Standard Terminology for Additive Manufacturing Technologies.” Conforming to this ASTM standard, “3D printer” is defined as “a machine used for 3D printing” and “3D printing” is defined as “manufacturing objects through the deposit of a material by means of a printhead, a nozzle or another printing technology.”

Additive manufacturing “AM” is defined as a process of joining materials for manufacturing objects from 3D model data, generally layer by layer, by contrast with subtractive manufacturing methods. The synonyms associated with 3D printing and encompassed by 3D printing comprise additive manufacturing, additive processes, additive techniques and manufacturing by layers. Additive manufacturing (AM) may also be called rapid prototyping (RP). As used here, “3D printing” is interchangeable with “additive manufacturing” and vice versa.

The irradiation of layers of silicon compositions X as printing progresses allows the rapid gelling of at least a part of the composition during the production and thus each layer retains the shape thereof without collapse of the printed structure.

Advantageously, the silicone compositions X according to the invention may be used for 3D printing methods implementing in tank photo polymerization (Digital Light Processing, stereolithography), material extrusion, material deposition, or inkjet, by adapting the viscosity of the silicone composition X to the technology used.

Other details or advantages of the invention will appear more clearly through examples given below solely for information.

### EXAMPLES

The silicone compositions described as examples below were obtained from the following raw materials:
A: poly(dimethylsiloxane) with terminal dimethyl(vinyl)silyls, viscosity≈100 MPa·s, comprising about 2% by weight of Si-vinyl function
B: poly(methyl hydrogen siloxane) with terminal trimethylsilyls containing 56% SiH function by weight
C1: Pt(octane-2,4-dione)₂ prepared according to example 1
C2: Pt(acac)₂ (0.1% solution in dichloromethane)
C3: Pt(heptane-3,5-dione)₂ prepared according to example 1 by using heptane-3,5-dione
C4: Pt(hexane-2,4-dione)₂ prepared according to example 1 by using hexane-2,4-dione
C5: mixture of Pt Karstedt-benzoquinone complexes according to patent application

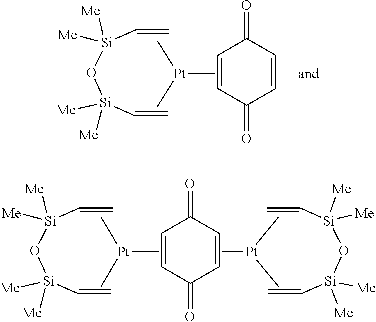

### Example 1: Synthesis of the Catalyst C1 Pt(Octane-2,4-Dione)₂, Characterization and Toxicity Test

A solution of NaOH (3.0 equivalents) in distilled water was added to octane-2,4-dione (4.0 equivalents) and the mixture was stirred at 70° C. for five minutes. The K₂PtCl₄ (500 mg, 1.20 mmol, 1.0 equivalents) was then added and the reaction mixture was stirred at 70° C. in the dark. The reaction changed color quickly from red to orange and then to yellow and a brown oil separated from the pale aqueous solution. The consumption of octane-2,4-dione was tracked by GC-FID, and no more change was observed after four hours. The mixture was then cooled to 25° C. and was diluted with CH₂Cl₂. The phases were separated and the aqueous phase was again extracted with CH₂Cl₂. The combined organic phases were then dried over Na₂SO₄, filtered and concentrated under reduced pressure giving a brown oily residue.

The purification was done by flash chromatography on silica gel (cyclohexane/EtOAc 75:25). Two fractions were obtained:
cis-Pt(octane-2,4-dione)₂ isolated in the form of a yellow solid with a 33% yield and a 99% purity (percent by mass determined by ¹H NMR), cis/trans ratio 91/9 (determined by 1H NMR).
trans Pt(octane-2,4-dione)₂ isolated in the form of a yellow solid with a 28% yield and a 98% purity (percent by mass determined by ¹H NMR), cis/trans ratio 4/96 (determined by ¹H NMR).

Cis-Pt(octane-2,4-dione)₂ (toluene-d8, 400 MHZ, 25° C.) δ=5.14 (s, 2H), 1.89 (t, J=7.6 Hz, 4H), 1.53 (s, 6H), 1.43 (quint, J=7.6 Hz, 4H), 1.13 (sext, J=7.2 Hz, 4H), 0.75 (t, J=7.2 Hz, 6H).

Trans-Pt(octane-2,4-dione)₂ (toluene-d8, 400 MHZ, 25° C.) δ=5.14 (s, 2H), 1.90 (t, J=7.6 Hz, 4H), 1.52 (s, 6H), 1.44 (quint, J=7.6 Hz, 4H), 1.14 (sext, J=7.6 Hz, 4H), 0.75 (t, J=7.2 Hz, 6H).

Toxicity test (Ames Test, according to the OECD guidelines for chemical product tests-test 471: Bacterial Reverse Mutation Test): Solutions were prepared with Pt(octane-2,4-dione)₂. They did not induce any mutagenic modification in Salmonella typhimurium TA 1535, TA 1537, TA 98, TA 100 and in Escherichia coli WP2 (uvrA-) (pKM 101) with or without metabolic activation for 5000, 1500, 150 and 50 μg/plate.

### Example 2: Determination of the Activity of the Catalyst

### Operational Method:

prepare a mother solution of catalysts C1 or C2 at 600 ppm Pt in hexamethyldisiloxane;
add 0.1 mL of mother solution to 5.5 g of organopolysiloxane A, and then add 0.29 g of organopolysiloxane B (molar ratio SiH/Si (vinyl)=2:1 and metal Pt concentration of 10 ppm); and
irradiate the solution under stirring (500 rpm) while keeping a flow of compressed air until the liquid becomes a gel and the mass is no longer stirred.

Irradiation: UV LED lamp with a wavelength of 365 nm.

The crosslinking time is measured. It corresponds to the bulk setting time of the system (the bar magnet can no longer stir the system). The results are shown in Table 1.

TABLE 1

| | | | Crosslinking |
|---|---|---|---|
| Trial | Catalyst | Solubility | time |
| Comparative | C2 | Sparingly soluble | 6 min 40 s |
| Trial 1 | | yellow suspension | |
| Trial 1 | C1 | Soluble clear yellow | 1 min 30 s |
| | Trans:cis ratio = 88:12 | medium | |
| Trial 2 | C1 | Soluble clear yellow | 1 min |
| | Trans:cis ratio = 11:89 | medium | |
| Trial 3 | C1 | Soluble clear yellow | 1 min 5 s |
| | Trans:cis ratio = 50:50 | medium | |

These results show that the silicone composition according to the invention has excellent properties. In fact, the crosslinking time under UV is shorter than with the reference catalyst Pt(acac)₂. Further, Pt(octane-2,4-dione)₂ has a better solubility in silicones.

### Example 3: Photo DSC Experiments

The pure form >90% of the complexes was isolated and evaluated by Photo-DSC (DSC=differential scanning calorimetry) with the same formulation as in example 2 for determining the time of the maximum reaction speed.

The time for reaching the maximum thermal flow in mW/s and the peak values are recorded in the following table.

### Operational Method:

a mother solution of catalyst with 600 ppm of Pt in hexamethyldisiloxane is prepared;
30 mg of the mother solution was added to 1.76 g of organopolysiloxane A, and then 48 mg of organopolysiloxane B were added. The resulting samples had a metal Pt concentration of 10 ppm. The photo-DSC experiments were done using a Mettler DSC system equipped with a Hamamatsu spot UV light source model LC8-02 under N2 purge.
Two waveguides coupled to the instrument transmitted equal photo doses to the sample cup and to an empty reference cup, while the DSC measured the thermal flow;
The light source is a mercury-xenon lamp with a 365 nm filter and the UV dose at 365 nm is 14.4 mW/cm²).

The results are shown in Table 2.

TABLE 2

| | | Time to arrive | Value of the | |
|---|---|---|---|---|
| | | at the thermal | thermal peak | |
| Trial | Catalyst | peak(s) | (mW/s) | Appearance |
| Trial 4 | C1 | 140 | 0.85 | Soluble clear |
| | Cis | | | yellow medium |
| Trial 5 | C1 | 140 | 0.78 | Soluble clear |
| | Trans | | | yellow medium |
| Comparative | C2 | 140 | 0.65 | Sparingly soluble |
| Trial 2 | | | | yellow suspension |
| Comparative | C3 | 240 | 0.53 | Clear yellow |
| Trial 3 | | | | solution |
| Comparative | C4 | 235 | 0.47 | Hazy yellow |
| Trial 4 | | | | solution with |
| | | | | undissolved |
| | | | | particles |
| Comparative | C5 | no peak | no peak | White and hazy |
| Trial 5 | | | | solution with |
| | | | | undissolved |
| | | | | particles |

These results show that the two diastereomers of Pt(octane-2,4-dione)₂ have a higher thermal peak than the reference catalysts, such as Pt(acac)₂. Higher peaks are desirable, because they correspond to higher activity. Further, the time for the two diastereomers of Pt(octane-2,4-dione)₂ to arrive at the thermal peak is comparable to or less than that of other catalysts tested. This shows a good reactivity of Pt(octane-2,4-dione)₂.

These results also show that the two diastereomers Pt(octane-2,4-dione)₂ have a solubility in the silicone composition which is comparable to or improved compared to other tested catalysts.

### Example 4: Determination of the Solubility of the Catalyst

The solubility of the various catalysts C1-C5 was determined in hexamethyldisiloxane (HMDSO) at 20° C. according to the following protocol.
1) Gather 5 mg of Pt catalyst and add 200 mg of HMDSO.
2) Stir for five minutes at 20° C. to suspend the catalyst and saturate the medium.
3) Dilute with HMDSO by successive additions (additions of 100 mg until a total of 1 g and then additions of 500 mg) while continuing stirring of the medium. Continue additions until obtaining a clear medium, without observing precipitate at the end of stirring.

The results are shown in Table 3.

TABLE 3

| Trial | Catalyst | Solubility | |
|---|---|---|---|
| Trial 6 | C1 | 7000 | ppm Pt |
| Comparative Trial 6 | C2 | <100 | ppm Pt |
| Comparative Trial 7 | C3 | 2500 | ppm Pt |
| Comparative Trial 8 | C4 | 500 | ppm Pt |
| Comparative Trial 9 | C5 | <100 | ppm Pt |

These results show that Pt(octane-2,4-dione)₂ (C1) has a much better solubility in silicones than other Pt based complexes and in particular other Pt β-diketonate (C3 and C4).

### Example 5: Determination of the Stability of the Catalyst

A solution comprising a catalyst C1 or C5, together with organopolysiloxanes A and B was prepared according to example 2 (concentration in metal Pt of 10 ppm).

The stability of the solutions was then determined.

The solution comprising Pt(octane-2,4-dione)₂ (C1) remained stable for over 20 days protected from light and over 7 hours exposed to ambient light.

The solution comprising the mixture of Pt Karstedt-benzoquinone complexes (C5) crosslinks at the end of five minutes protected from light.

These results show that the silicone composition according to the invention has very good stability without irradiation. In fact, the gel time without irradiation is very long and much longer than that obtained with the mixture of Pt Karstedt-benzoquinone complexes (C5).

1-10. (canceled)

11. A silicone composition X cross-linkable by irradiation comprising:
(a) at least one organopolysiloxane A having, per molecule, at least two alkenyl groups in C₂-C₁₂ bound to silicon;
(b) at least one organopolysiloxane B having, per molecule, at least two SiH units; and
(c) a catalytically effective quantity of at least one hydrosilylation catalyst C, which is Pt(octane-2,4-dione)₂.

12. The silicone composition X according to claim 11, wherein Pt(octane-2,4-dione)₂ is a mixture of cis and trans diastereomers

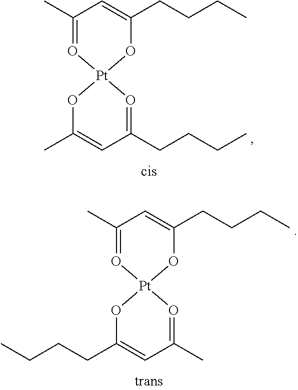

13. The silicone composition X according to claim 11, wherein the silicone composition X is cross-linkable by exposure to radiation with a wavelength included between 100 nm and 450 nm.

14. The silicone composition X according to claim 11, wherein the quantity by weight of catalyst C, calculated by weight of metal platinum, is included between 1 and 400 ppm based on the total weight of the silicone composition X.

15. A method for preparation of a coating on a support, comprising the following steps:
applying the silicone composition X according to claim 11 on a support; and
crosslinking of said composition by electronic or photonic irradiation.

16. The method according to claim 15, wherein the crosslinking takes place by exposure to UV radiation from a UV-LED lamp.

17. A coated support obtained by the method from claim 15.

18. A method for preparation of silicone elastomer, comprising cross-linking the silicone composition X according to claim 11 by a polyaddition reaction.

19. A method for hydrosilylation, comprising hydrosilylation with Pt(octane-2,4-dione)₂ as a catalyst.

20. A premix for a silicone composition comprising:
at least one organopolysiloxane A having, per molecule, at least two alkenyl groups in C₂-C₁₂ bound to the silicon; and
at least one hydrosilylation catalyst C, which is Pt(octane-2,4-dione)₂.
